(19) United States
(12) Patent Application Publication
(10) Pub. No.: US 2020/0332979 A1
(43) Pub. Date: Oct. 22, 2020

(54) LAMP, LIGHT EMITTING MODULE, AND COMBINED LENS THEREOF

(71) Applicant: KAISTAR Lighting(Xiamen) Co., Ltd., Xiamen (CN)

(72) Inventors: WEN-LONG ZHANG, Xiamen (CN); JIA-BIN XU, Xiamen (CN)

(21) Appl. No.: 16/918,815

(22) Filed: Jul. 1, 2020

(30) Foreign Application Priority Data
Nov. 5, 2019 (CN) 201911071080.9

(51) Int. Cl. F21V 3/04; F21V 5/04; F21K 9/232; F21V 17/10; F21K 9/66; F21K 9/69

(52) U.S. Cl. CPC F21V 3/049; F21V 5/045; F21K 9/232; F21Y 2115/10; F21K 9/66; F21K 9/69; F21V 17/101

(57) ABSTRACT

A lamp, a light emitting module, and a combined lens thereof are provided. The combined lens includes a first lens portion and a second lens portion. The first lens portion has a surrounding lateral surface, an incident surface arranged inside of the surrounding lateral surface, and an exit surface opposite to the incident surface. The second lens portion includes a light diffusion surface and a light output surface. The light diffusion surface is spaced apart from and face toward the exit surface, and has a plurality of light diffusion microstructures that are arranged on a projection region defined by orthogonally projecting the exit surface onto the light diffusion surface. The combined lens is configured to guide light therein to travel out through the light output surface by passing through the exit surface and the light diffusion microstructures.

### CROSS-REFERENCE TO RELATED PATENT APPLICATION

This application claims the benefit of priority to Patent Application No. 201911071080.9, filed on Nov. 5, 2019 in People's Republic of China. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a lens, and more particularly to a lamp, a light emitting module, and a combined lens thereof.

### BACKGROUND OF THE DISCLOSURE

A conventional lens is provided with a light diffusion portion that is formed by implementing a light diffusion treatment onto an outer portion (e.g., a light output surface) thereof for emitting uniform light. However, the light diffusion portion of the conventional lens is easily affected by external factors so as to affect the optical performance of the uniform light.

### SUMMARY OF THE DISCLOSURE

In response to the above-referenced technical inadequacies, the present disclosure provides a lamp, a light emitting module, and a combined lens thereof to effectively improve on the issues associated with conventional lenses.

In one aspect, the present disclosure provides a combined lens of a light emitting module, which includes a first lens portion and a second lens portion. The first lens portion has a surrounding lateral surface configured to reflect light, an incident surface arranged inside of the surrounding lateral surface, and an exit surface that is opposite to the incident surface. The incident surface surroundingly defines a slot-like space. A position of the second lens portion and a position of the first lens portion relative to each other are maintained. The second lens portion includes a light diffusion surface and a light output surface. The light diffusion surface is spaced apart from and faces toward the exit surface. The light diffusion surface has a plurality of light diffusion microstructures that are arranged on a projection region defined by orthogonally projecting the exit surface onto the light diffusion surface. The light diffusion surface and the light output surface are arranged on two opposite sides of the second lens portion, respectively. When light travels in the combined lens by passing through the incident surface, the combined lens is configured to guide the light therein to travel out through the light output surface by passing through the exit surface and the light diffusion microstructures.

In certain embodiments, a distance between the light diffusion surface and the exit surface is equal to or less than a distance between the light diffusion surface and the light output surface.

In certain embodiments, the combined lens further includes a gaseous medium layer arranged between the light diffusion surface and the exit surface, and the light diffusion microstructures are exposed in the gaseous medium layer.

In certain embodiments, the combined lens further includes a light permeable adhesive arranged between and adhered to the light diffusion surface and the exit surface, and the light diffusion microstructures are embedded in the light permeable adhesive.

In certain embodiments, the surrounding lateral surface and the light output surface of the combined lens are formed without any light diffusion microstructure thereon.

In one aspect, the present disclosure provides a light emitting module, which includes a combined lens and a light emitting unit. The combined lens includes a first lens portion and a second lens portion. The first lens portion has a surrounding lateral surface configured to reflect light, an incident surface arranged inside of the surrounding lateral surface, and an exit surface that is opposite to the incident surface. The incident surface surroundingly defines a slot-like space. A position of the second lens portion and a position of the first lens portion relative to each other are maintained. The second lens portion includes a light diffusion surface and a light output surface. The light diffusion surface is spaced apart from and faces toward the exit surface. The light diffusion surface has a plurality of light diffusion microstructures that are arranged on a projection region defined by orthogonally projecting the exit surface onto the light diffusion surface. The light diffusion surface and the light output surface are arranged on two opposite sides of the second lens portion, respectively. The light emitting unit is configured to emit light toward the incident surface of the combined lens. When the light emitted from the light emitting unit travels in the combined lens by passing through the incident surface, the combined lens is configured to guide the light therein to travel out through the light output surface by passing through the exit surface and the light diffusion microstructures.

In certain embodiments, the combined lens defines a central axis, and the light emitting unit is located at the central axis and is arranged outside of the slot-like space.

In certain embodiments, the combined lens defines a central axis, the light emitting unit is located at the central axis, and at least part of the light emitting unit is arranged inside of the slot-like space.

In certain embodiments, a distance between the light diffusion surface and the exit surface is equal to or less than a distance between the light diffusion surface and the light output surface.

In certain embodiments, the combined lens includes a gaseous medium layer arranged between the light diffusion surface and the exit surface, and the light diffusion microstructures are exposed in the gaseous medium layer.

In certain embodiments, the combined lens includes a light permeable adhesive arranged between and adhered to the light diffusion surface and the exit surface, and the light diffusion microstructures are embedded in the light permeable adhesive.

In certain embodiments, the surrounding lateral surface and the light output surface of the combined lens are formed without any light diffusion microstructure thereon.

In one aspect, the present disclosure provides a lamp, which includes a combined lens, a light emitting unit, and a carrier. The combined lens includes a first lens portion and a second lens portion. The first lens portion has a surrounding lateral surface configured to reflect light, an incident surface arranged inside of the surrounding lateral surface, and an exit surface that is opposite to the incident surface. The incident surface surroundingly defines a slot-like space. A position of the second lens portion and a position of the first lens portion relative to each other are maintained. The second lens portion includes a light diffusion surface and a light output surface. The light diffusion surface is spaced apart from and faces toward the exit surface. The light diffusion surface has a plurality of light diffusion microstructures that are arranged on a projection region defined by orthogonally projecting the exit surface onto the light diffusion surface. The light diffusion surface and the light output surface are arranged on two opposite sides of the second lens portion, respectively. The light emitting unit is configured to emit light toward the incident surface of the combined lens. The carrier is configured to be detachably assembled to an external power. The light emitting unit is fixed to and electrically coupled to the carrier, and the combined lens is fastened to the carrier and is arranged at one side of the light emitting unit. When the carrier receives an electricity from the external power to drive the light emitting unit to emit light that tends to travel in the combined lens by passing through the incident surface, the combined lens is configured to guide the light therein to travel out through the light output surface by passing through the exit surface and the light diffusion microstructures.

In certain embodiments, the second lens portion includes a light permeable board and a peripheral flange that is formed on a peripheral edge of the light permeable board, the light diffusion surface is arranged on an inner surface of the light permeable board, and the light output surface is arranged on an outer surface of the light permeable board. The exit surface and a portion of the surrounding lateral surface adjacent thereto of the first lens portion are arranged in a space surroundingly defined by the peripheral flange, and the peripheral flange of the second lens portion is engaged with the carrier.

In certain embodiments, a distance between the light diffusion surface and the exit surface is equal to or less than a distance between the light diffusion surface and the light output surface.

In certain embodiments, the combined lens includes a gaseous medium layer arranged between the light diffusion surface and the exit surface, and the light diffusion microstructures are exposed in the gaseous medium layer.

In certain embodiments, the combined lens includes a light permeable adhesive arranged between and adhered to the light diffusion surface and the exit surface, and the light diffusion microstructures are embedded in the light permeable adhesive.

In certain embodiments, the surrounding lateral surface and the light output surface of the combined lens are formed without any light diffusion microstructure thereon.

In certain embodiments, the combined lens defines a central axis, and the light emitting unit is located at the central axis and is arranged outside of the slot-like space.

In certain embodiments, the combined lens defines a central axis, the light emitting unit is located at the central axis, and at least part of the light emitting unit is arranged inside of the slot-like space.

Therefore, the light diffusion microstructures in the present disclosure are formed in an interior of the combined lens and are arranged on the projection region, so that lights traveling out of the exit surface of the first lens portion can be diffused and softened by the light diffusion microstructures. Moreover, the light diffusion microstructures are not easily affected by factors other than the combined lens so as to effectively ensure the optical performance of the combined lens.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a planar view of a lamp according to a first embodiment of the present disclosure.

FIG. 2 is a cross-sectional view of FIG. 1.

FIG. 3 is an enlarged view of portion III of FIG. 2.

FIG. 4 is an exploded view showing a combined lens according to the first embodiment of the present disclosure.

FIG. 5 is a cross-sectional view showing a combined lens according to a second embodiment of the present disclosure.

FIG. 6 is a cross-sectional view showing a combined lens according to a third embodiment of the present disclosure.

FIG. 7 is a cross-sectional view showing a combined lens according to a fourth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

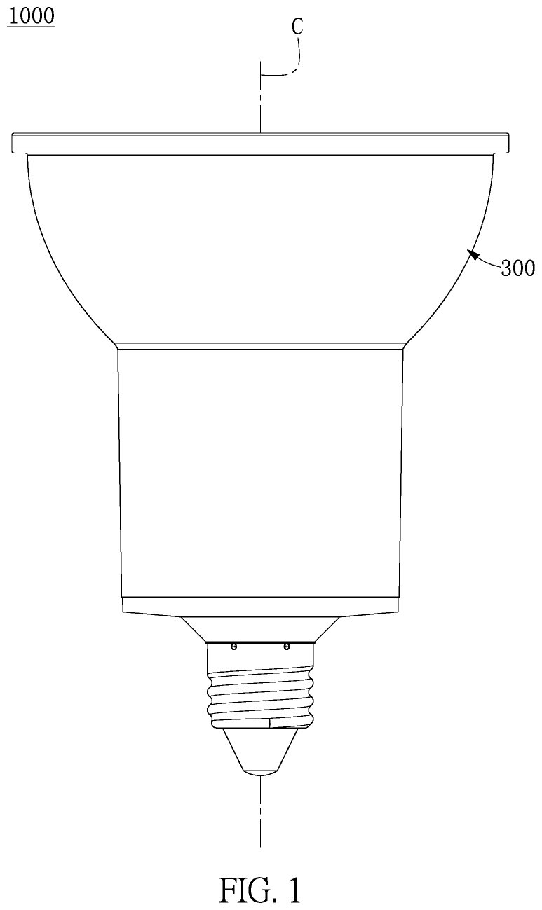

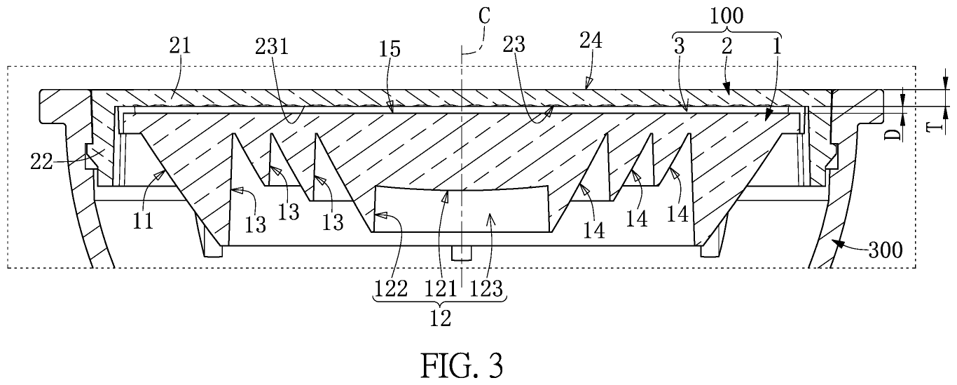

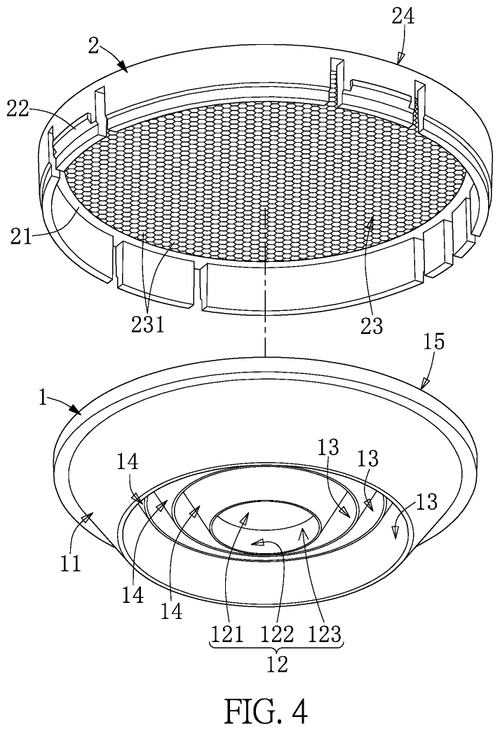

Referring to FIG. 1 to FIG. 4, a first embodiment of the present disclosure provides a lamp 1000 that is a light bulb, but the present disclosure is not limited thereto. The lamp 1000 includes a combined lens 100, a light emitting unit 200 corresponding in position to the combined lens 100, and a carrier 300 that provides installation of the combined lens 100 and the light emitting unit 200. Moreover, the combined lens 100 applied in the lamp 1000 in the present embodiment is preferably used in a lighting field, so that the combined lens 100 of the present embodiment is different from other lenses used in other fields (e.g., an image-capturing field).

It should be noted that the combined lens 100 and the light emitting unit 200 in the present embodiment can be jointly maned as a light emitting module. The combined lens 100 in the present embodiment is used in cooperation with the light emitting unit 200 and the carrier 300 (i.e., the light emitting module is used in cooperation with the carrier 300), but the present disclosure is not limited thereto. In other embodiments of the present disclosure, the combined lens 100 or the light emitting module can be independently used (e.g., sold) or can be used in cooperation with other components.

The combined lens 100 in the present embodiment defines a central axis C, and the combined lens 100 is symmetrical to the central axis C. The combined lens 100 includes a first lens portion 1 and a second lens portion 2. Moreover, a position of the second lens portion 2 and a position of the first lens portion 1 relative to each other are maintained, and the first lens portion 1 and the second lens portion 2 are spaced apart from each other. In other words, the first lens portion 1 and the second lens portion 2 in the present embodiment are different from any two lens portions that are not spaced apart from each other.

Specifically, the first lens portion 1 and the second lens portion 2 in the present embodiment are maintained the relative position thereof by being fastened to the carrier 300, but the present disclosure is not limited thereto. For example, in other embodiments of the present disclosure, the relative position of the first lens portion 1 and the second lens portion 2 can be maintained by an adhering manner, an ultrasonic welding manner, an external component fixing manner (e.g., a screwing manner), or other connection manners.

The first lens portion 1 is integrally formed as a one-piece structure, and outer surfaces of the first lens portion 1 include a surrounding lateral surface 11, an incident surface 12 arranged inside of the surrounding lateral surface 11, a plurality of side incident surfaces 13 and a plurality of reflecting surfaces 14 those are arranged between the surrounding lateral surface 11 and the incident surface 12, and an exit surface 15 that is opposite to the incident surface 12. The central axis C passes through the incident surface 12 and the exit surface 15. The surrounding lateral surface 11, the side incident surfaces 13, and the reflecting surfaces 14 each surround (or each are arranged around) the central axis C. The incident surface 12, the side incident surfaces 13, and the reflecting surfaces 14 in the present embodiment are arranged in a space surroundingly defined by the surrounding lateral surface 11, but the present disclosure is not limited thereto.

Specifically, the surrounding lateral surface 11 in the present embodiment is substantially in a circular ring shape having a center located at the central axis C, and the surrounding lateral surface 11 is configured to reflect light that travels in the first lens portion 1, so that the light can tend to travel toward the exit surface 15. It should be noted that the surrounding lateral surface 11 in the present embodiment is not processed by any light diffusion treatment. In other words, the surrounding lateral surface 11 of the combined lens 100 does not have any light diffusion microstructure. Accordingly, any lens having light diffusion microstructures on a surrounding lateral surface thereof is different from the first lens portion 1 of the present embodiment.

The incident surface 12 in the present embodiment includes a forward incident region 121 passed there-through by the central axis C and a lateral incident region 122 that is connected to the forward incident region 121. An edge of the forward incident region 121 is substantially in a circular shape having a center located at the central axis C, and the lateral incident region 122 is substantially and perpendicularly connected to the edge of the forward incident region 121, so that the incident surface 12 can surroundingly define a slot-like space 123.

The side incident surfaces 13 and the reflecting surfaces 14 are staggered with each other and are arranged between the lateral incident region 122 and the surrounding lateral surface 11. The lateral incident surface 122 and the side incident surface 13 adjacent thereto are provided with one of the reflecting surfaces 14 arranged there-between, and any two of the side incident surfaces 13 adjacent to each other are provided with another one of the reflecting surfaces 14 arranged there-between. The function of each of the side incident surfaces 13 is similar to that of the lateral incident region 122, and the function of each of the reflecting surfaces 14 is similar to that of the surrounding lateral surface 11. Moreover, any one of the reflecting surfaces 14 in the present embodiment is not processed by any light diffusion treatment (e.g., any one of the reflecting surfaces 14 does not have any light diffusion microstructure). Accordingly, any lens having light diffusion microstructures on a reflecting surface thereof is different from the first lens portion 1 of the present embodiment.

The exit surface 15 in the present embodiment is a planar surface having a center located at the central axis C, and the exit surface 15 is perpendicular to the central axis C. The exit surface 15 in the present embodiment is not processed by any light diffusion treatment (e.g., the exit surface 15 does not have any light diffusion microstructure). Accordingly, any lens having light diffusion microstructures on an exit surface thereof is different from the first lens portion 1 of the present embodiment.

Since the first lens portion 1 is formed with the incident surface 12 and the side incident surfaces 13, so that lights can tend to travel into the first lens portion 1 at different incident angles. Moreover, the lights can travel in the first lens portion 1 along different refraction paths through the incident surface 12 and the side incident surfaces 13, and the different refraction paths related to the incident surface 12 and the side incident surfaces 13 can further affect or generate different refraction paths, so that the lights can be diffused onto the exit surface 15 to increase the light uniformity of the exit surface 15 of the first lens portion 1.

The second lens portion 2 is integrally formed as a one-piece structure, and the second lens portion 2 in the present embodiment includes a light permeable board 21 and a peripheral flange 22 that is formed on a peripheral edge of the light permeable board 21. The light permeable board 21 in the present embodiment is a flat and transparent structure, and the peripheral flange 22 is substantially and perpendicularly connected to the light permeable board 21.

Specifically, a part of the outer surfaces of the first lens portion 1 (e.g., the exit surface 15, a part of the surrounding lateral surface 11 adjacent to the exit surface 15, a portion of the incident surface 12, at least part of each of the side incident surfaces 13, and at least part of each of the reflecting surfaces 14) can be arranged in a space surroundingly defined by the peripheral flange 22, and the peripheral flange 22 of the second lens portion 2 is engaged with the carrier 300.

In other words, outer surfaces of the second lens portion 2 include a light diffusion surface 23 and a light output surface 24 respectively arranged on two opposite sides thereof. In the present embodiment, the light diffusion surface 23 is arranged on an inner surface of the light permeable board 21, and the light output surface 24 is arranged on an outer surface of the light permeable board 21. The light diffusion surface 23 of the second lens portion 2 and the exit surface 15 of the first lens portion 1 are spaced apart from and face toward each other. A distance D between the light diffusion surface 23 and the exit surface 15 is preferably equal to or less than a distance between the light diffusion surface 23 and the light output surface 24 (i.e., a thickness T of the light permeable board 21), but the present disclosure is not limited thereto.

Specifically, the light diffusion surface 23 is the inner surface of the second lens portion 2 that is processed by a light diffusion treatment. The light diffusion treatment can be implemented by coating, setting up dense and expected curvature structures, frosting, or forming reflective prisms, but the present disclosure is not limited thereto. For the structural description of the light diffusion surface 23, the light diffusion surface 23 has a plurality of light diffusion microstructures 231 by the light diffusion treatment, and the light diffusion microstructures 231 are arranged on a projection region defined by orthogonally projecting the exit surface 15 onto the light diffusion surface 23. It should be noted that the specific structure of the light diffusion microstructures 231 of the present disclosure can be changed or adjusted according to design requirements and is not limited to that shown in the drawings of the present embodiment.

Moreover, the light output surface 24 in the present embodiment is a planar surface having a center located at the central axis C. However, in other embodiments of the present disclosure, the light output surface 24 can be a concave surface or a convex surface according to design requirements. It should be noted that the light output surface 24 in the present embodiment is not processed by any light diffusion treatment. In other words, the light output surface 24 of the combined lens 100 does not have any light diffusion microstructure. Accordingly, any lens having light diffusion microstructures on a light output surface thereof is different from the second lens portion 2 of the present embodiment.

In addition, the combined lens 100 of the present embodiment includes a gaseous medium layer 3 arranged between the light diffusion surface 23 and the exit surface 15, so that the first lens portion 1 and the second lens portion 2 can be spaced apart from each other. Moreover, the light diffusion microstructures 231 of the light diffusion surface 23 are exposed in the gaseous medium layer 3. The gaseous medium layer 3 in the present embodiment is an air layer, but the present disclosure is not limited thereto.

Accordingly, the light diffusion microstructures 231 are formed in an interior of the combined lens 100 and are arranged on the projection region, so that lights traveling out of the exit surface 15 of the first lens portion 1 can be diffused and softened by the light diffusion microstructures 231. Moreover, the light diffusion microstructures 231 are not easily affected by factors other than the combined lens 100 so as to effectively ensure the optical performance of the combined lens 100.

Specifically, the combined lens 100 can be formed with at least part of the above structural features (e.g., the distance D between the light diffusion surface 23 and the exit surface 15 is equal to or less than the thickness T of the light permeable board 21; the light diffusion microstructures 231 are exposed in the gaseous medium layer 3; and the surrounding lateral surface 11 and the light output surface 24 do not have any light diffusion microstructure) so as to increase the optical performance of the combined lens 100.

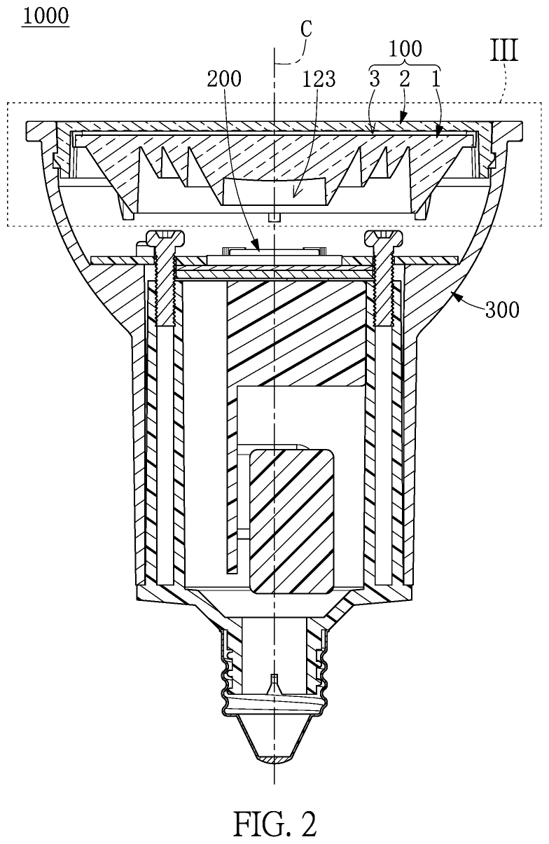

The light emitting unit 200 in the present embodiment includes at least one light emitting diode (LED) chip, but the present disclosure is not limited thereto. The light emitting unit 200 is fixed to and electrically coupled to the carrier 300, and the combined lens 100 is fastened to the carrier 300 and is arranged at one side of the light emitting unit 200 (e.g., an upper side of the light emitting unit 200 shown in FIG. 2). Specifically, the light emitting unit 200 is located at the central axis and is arranged outside of the slot-like space 123 (e.g., the light emitting unit 200 is direct located under the forward incident region 121), and the light emitting unit 200 is configured to emit light toward the incident surface 12 and the side incident surfaces 13 of the first lens portion 1.

Moreover, the carrier 300 in the present embodiment is configured to be detachably assembled to an external power (e.g., a bulb holder) for obtaining electricity to drive of the lamp 1000. Specifically, when the carrier 300 receives an electricity from the external power to drive the light emitting unit 200 to emit light that tends to travel in the combined lens 100 by passing through the incident surface 12 and the side incident surfaces 13, the combined lens 100 is configured to guide the light therein to travel out through the light output surface 24 by passing through the exit surface 15 and the light diffusion microstructures 231.

### Second Embodiment

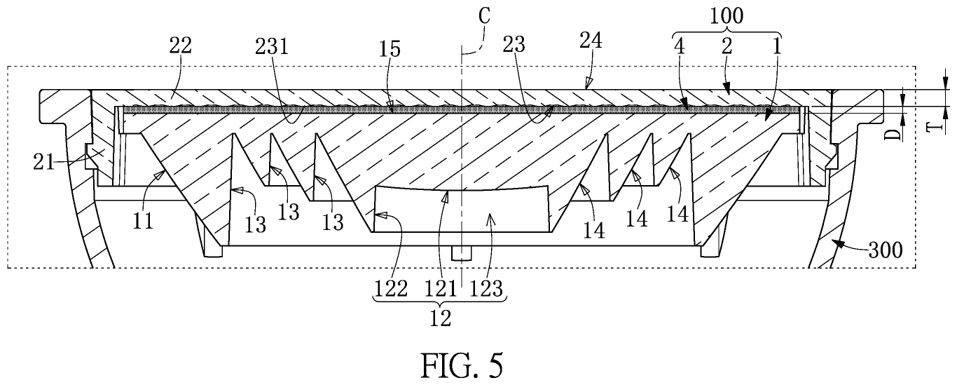

Referring to FIG. 5, a second embodiment of the present disclosure is similar to the first embodiment of the present disclosure. For the sake of brevity, descriptions of the same components in the first and second embodiments of the present disclosure will be omitted herein, and the following description only discloses different features between the first and second embodiments that reside in the combined lens 100.

In the present embodiment, the combined lens 100 further includes a light permeable adhesive 4 arranged between and adhered to the light diffusion surface 23 and the exit surface 15. In other words, the gaseous medium layer 3 of the present embodiment is replaced by the light permeable adhesive 4 of the present embodiment. Moreover, the light diffusion microstructures 231 are embedded in the light permeable adhesive 4.

Specifically, the exit surface 15 and the light diffusion surface 23 in the present embodiment are covered entirely and adhered to the light permeable adhesive 4, so that the relative position of the first lens portion 1 and the second lens portion 2 can be maintained by the light permeable adhesive 4. It should be noted that the light permeable adhesive 4 in the present embodiment is transparent, and the material and the refractive index of the light permeable adhesive 4 can be changed or adjusted according to design requirements.

### Third Embodiment

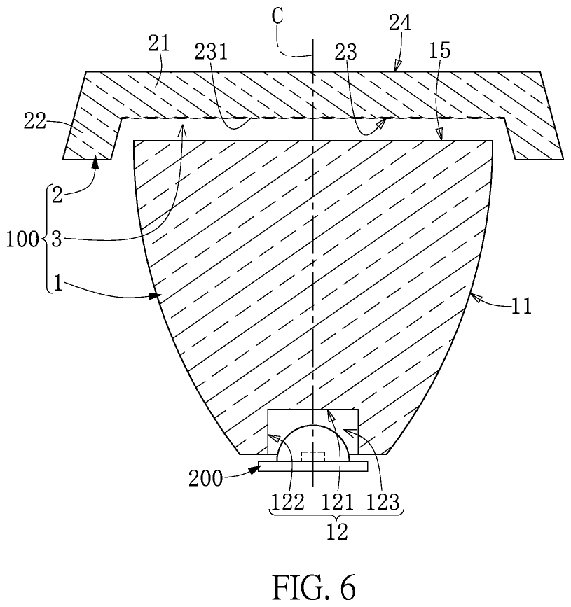

Referring to FIG. 6, a third embodiment of the present disclosure is similar to the first embodiment of the present disclosure. For the sake of brevity, descriptions of the same components in the first and third embodiments of the present disclosure will be omitted herein, and the following description only discloses different features between the first and third embodiments that reside in the light emitting module.

In the present embodiment, outer surfaces of the first lens portion 1 only include a surrounding lateral surface 11, an incident surface 12 arranged inside of the surrounding lateral surface 11, and an exit surface 15 that is opposite to the incident surface 12 and that is connected to the surrounding lateral surface 11 (e.g., the first lens portion 1 is formed without the side incident surfaces 13 and the reflecting surfaces 14). Specifically, the incident surface 12 surroundingly defines a slot-like space 123, the light emitting unit 200 is located at the central axis C, and at least part of the light emitting unit 200 is arranged in the slot-like space 123.

### Fourth Embodiment

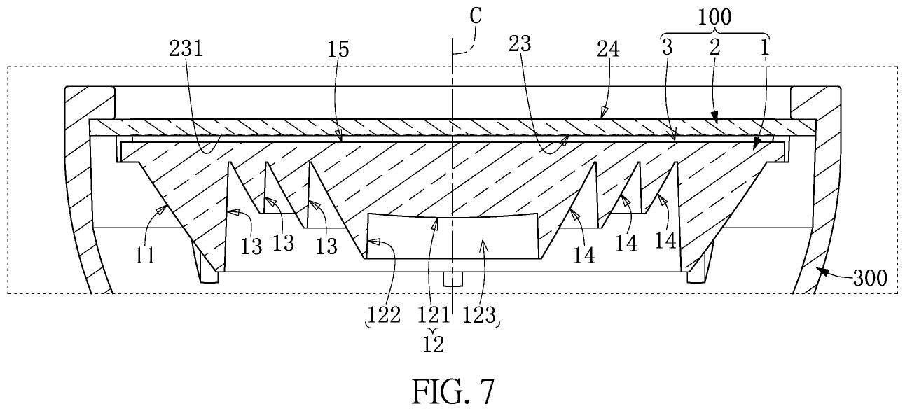

Referring to FIG. 7, a fourth embodiment of the present disclosure is similar to the first embodiment of the present disclosure. For the sake of brevity, descriptions of the same components in the first and fourth embodiments of the present disclosure will be omitted herein, and the following description only discloses different features between the first and fourth embodiments that reside in the combined lens 100.

In the present embodiment, the second lens portion 2 can be a flat board (i.e., the second lens portion 2 does not have the peripheral flange 22), and the relative position of the first lens portion 1 and the second lens portion 2 can be maintained by external components other than the combined lens 100. Specifically, the relative position of the first lens portion 1 and the second lens portion 2 in the present embodiment is maintained by the carrier 300, but the present disclosure is not limited thereto.

In conclusion, the light diffusion microstructures in the present disclosure are formed in an interior of the combined lens and are arranged on the projection region, so that lights traveling out of the exit surface of the first lens portion can be diffused and softened by the light diffusion microstructures. Moreover, the light diffusion microstructures are not easily affected by factors other than the combined lens so as to effectively ensure the optical performance of the combined lens.

Specifically, the combined lens in the present disclosure can be formed with at least part of the above structural features (e.g., the distance between the light diffusion surface and the exit surface is equal to or less than the thickness of the light permeable board; the light diffusion microstructures are exposed in the gaseous medium layer; and the surrounding lateral surface and the light output surface do not have any light diffusion microstructure) so as to increase the optical performance of the combined lens.

Moreover, since the first lens portion in the present disclosure is formed with the incident surface and the side incident surfaces, so that lights can tend to travel into the first lens portion at different incident angles. Furthermore, the lights can travel in the first lens portion along different refraction paths through the incident surface and the side incident surfaces, and the different refraction paths related to the incident surface and the side incident surfaces can further affect or generate different refraction paths, so that the lights can be diffused onto the exit surface to increase the light uniformity of the exit surface of the first lens portion.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A combined lens of a light emitting module, comprising:
a first lens portion having a surrounding lateral surface configured to reflect light, an incident surface arranged inside of the surrounding lateral surface, and an exit surface that is opposite to the incident surface, wherein the incident surface surroundingly defines a slot-like space; and
a second lens portion, wherein a position of the second lens portion and a position of the first lens portion relative to each other are maintained, and the second lens portion includes:
a light diffusion surface spaced apart from and facing toward the exit surface, wherein the light diffusion surface has a plurality of light diffusion microstructures that are arranged on a projection region defined by orthogonally projecting the exit surface onto the light diffusion surface; and
a light output surface, wherein the light diffusion surface and the light output surface are arranged on two opposite sides of the second lens portion, respectively,
wherein when light travels in the combined lens by passing through the incident surface, the combined lens is configured to guide the light therein to travel out through the light output surface by passing through the exit surface and the light diffusion microstructures.

2. The combined lens according to claim 1, wherein a distance between the light diffusion surface and the exit surface is equal to or less than a distance between the light diffusion surface and the light output surface.

3. The combined lens according to claim 1, further comprising a gaseous medium layer arranged between the light diffusion surface and the exit surface, and the light diffusion microstructures are exposed in the gaseous medium layer.

4. The combined lens according to claim 1, further comprising a light permeable adhesive arranged between and adhered to the light diffusion surface and the exit surface, and the light diffusion microstructures are embedded in the light permeable adhesive.

5. The combined lens according to claim 1, wherein the surrounding lateral surface and the light output surface of the combined lens are formed without any of the light diffusion microstructures thereon.

6. A light emitting module, comprising:
a combined lens including:
a first lens portion having a surrounding lateral surface configured to reflect light, an incident surface arranged inside of the surrounding lateral surface, and an exit surface that is opposite to the incident surface, wherein the incident surface surroundingly defines a slot-like space; and
a second lens portion, wherein a position of the second lens portion and a position of the first lens portion relative to each other are maintained, and the second lens portion includes:
a light diffusion surface spaced apart from and facing toward the exit surface, wherein the light diffusion surface has a plurality of light diffusion microstructures that are arranged on a projection region defined by orthogonally projecting the exit surface onto the light diffusion surface; and
a light output surface, wherein the light diffusion surface and the light output surface are arranged on two opposite sides of the second lens portion, respectively; and
a light emitting unit configured to emit light toward the incident surface of the combined lens, wherein when the light emitted from the light emitting unit travels in the combined lens by passing through the incident surface, the combined lens is configured to guide the light therein to travel out through the light output surface by passing through the exit surface and the light diffusion microstructures.

7. The light emitting module according to claim 6, wherein the combined lens defines a central axis, and the light emitting unit is located at the central axis and is arranged outside of the slot-like space.

8. The light emitting module according to claim 6, wherein the combined lens defines a central axis, the light emitting unit is located at the central axis, and at least part of the light emitting unit is arranged inside of the slot-like space.

9. The light emitting module according to claim 6, wherein a distance between the light diffusion surface and the exit surface is equal to or less than a distance between the light diffusion surface and the light output surface.

10. The light emitting module according to claim 6, wherein the combined lens includes a gaseous medium layer arranged between the light diffusion surface and the exit surface, and the light diffusion microstructures are exposed in the gaseous medium layer.

11. The light emitting module according to claim 6, wherein the combined lens includes a light permeable adhesive arranged between and adhered to the light diffusion surface and the exit surface, and the light diffusion microstructures are embedded in the light permeable adhesive.

12. The light emitting module according to claim 6, wherein the surrounding lateral surface and the light output surface of the combined lens are formed without any light diffusion microstructure thereon.

13. A lamp, comprising:
a combined lens including:
a first lens portion having a surrounding lateral surface configured to reflect light, an incident surface arranged inside of the surrounding lateral surface, and an exit surface that is opposite to the incident surface, wherein the incident surface surroundingly defines a slot-like space; and
a second lens portion, wherein a position of the second lens portion and a position of the first lens portion relative to each other are maintained, and the second lens portion includes:
a light diffusion surface spaced apart from and facing toward the exit surface, wherein the light diffusion surface has a plurality of light diffusion microstructures that are arranged on a projection region defined by orthogonally projecting the exit surface onto the light diffusion surface; and
a light output surface, wherein the light diffusion surface and the light output surface are arranged on two opposite sides of the second lens portion, respectively;
a light emitting unit configured to emit light toward the incident surface of the combined lens; and
a carrier configured to be detachably assembled to an external power, wherein the light emitting unit is fixed to and electrically coupled to the carrier, and the combined lens is fastened to the carrier and is arranged at one side of the light emitting unit,
wherein when the carrier receives an electricity from the external power to drive the light emitting unit to emit light that tends to travel in the combined lens by passing through the incident surface, the combined lens is configured to guide the light therein to travel out through the light output surface by passing through the exit surface and the light diffusion microstructures.

14. The lamp according to claim 13, wherein the second lens portion includes a light permeable board and a peripheral flange that is formed on a peripheral edge of the light permeable board, the light diffusion surface is arranged on an inner surface of the light permeable board, and the light output surface is arranged on an outer surface of the light permeable board, and wherein the exit surface and a portion of the surrounding lateral surface adjacent thereto of the first lens portion are arranged in a space surroundingly defined by the peripheral flange, and the peripheral flange of the second lens portion is engaged with the carrier.

15. The lamp according to claim 13, wherein a distance between the light diffusion surface and the exit surface is equal to or less than a distance between the light diffusion surface and the light output surface.

16. The lamp according to claim 13, wherein the combined lens includes a gaseous medium layer arranged between the light diffusion surface and the exit surface, and the light diffusion microstructures are exposed in the gaseous medium layer.

17. The lamp according to claim 13, wherein the combined lens includes a light permeable adhesive arranged between and adhered to the light diffusion surface and the exit surface, and the light diffusion microstructures are embedded in the light permeable adhesive.

18. The lamp according to claim 13, wherein the surrounding lateral surface and the light output surface of the combined lens are formed without any light diffusion microstructure thereon.

19. The lamp according to claim 13, wherein the combined lens defines a central axis, and the light emitting unit is located at the central axis and is arranged outside of the slot-like space.

20. The lamp according to claim 13, wherein the combined lens defines a central axis, the light emitting unit is located at the central axis, and at least part of the light emitting unit is arranged inside of the slot-like space.
